(19) United States
(12) Patent Application Publication
(10) Pub. No.: US 2026/0088908 A1
(43) Pub. Date: Mar. 26, 2026

(54) DEMODULATION OF PHASE- OR FREQUENCY-MODULATED OPTICAL SIGNALS USING RING RESONATORS

(71) Applicant: Raytheon Company, Tewksbury, MA (US)

(72) Inventors: Benjamin P. Dolgin, Aventura, FL (US); Andrew M. Kowalevicz, Alexandria, VA (US); Gary M. Graceffo, Fairfax Station, VA (US)

(21) Appl. No.: 18/893,629

(22) Filed: Sep. 23, 2024

(51) Int. Cl. H04B 10/60; G02B 6/293; H04B 10/2581

(52) U.S. Cl. CPC H04B 10/60; G02B 6/29338; G02B 6/2938; H04B 10/2581

(57) ABSTRACT

A method includes receiving a modulated optical signal at a ring resonator. The ring resonator has a ring with a ring length and includes a coupling region. The method also includes splitting the modulated optical signal into a first portion and a second portion. The method further includes mixing a previous first portion of the modulated optical signal with the second portion of the modulated optical signal to obtain a mixed signal. In addition, the method includes measuring a measured energy of the mixed signal using a photodetector. The symbol has a symbol length. A coupling coefficient expressing a measured energy of the first portion relative to a measured energy of the modulated optical signal has a value of less than 50%.

### TECHNICAL FIELD

This disclosure relates generally to optical systems. More specifically, this disclosure relates to demodulation of modulated optical signals using ring resonators.

### BACKGROUND

Increasing the efficiency of systems that encode data as modulations of a parameter (such as phase, frequency or amplitude) of a waveform, transmit the modulated waveform to a receiver over a transmission medium, and recover the encoded data through demodulation of the waveform is a persistent challenge. When data is encoded by modulating the phase of a carrier signal, technical challenges associated with achieving system efficiency can include minimizing the effects of inter-symbol interference (ISI), where energy from previously-transmitted data interfere with the demodulation and recovery of subsequently-transmitted data.

### SUMMARY

This disclosure relates to demodulation of phase or frequency modulated laser optical signals using ring resonators.

In some embodiments, an optical demodulator includes a ring resonator having a ring with a ring length Δτ and comprising an input region, a coupling region and an output region. The ring resonator can be configured to receive, at the input region over time, a modulated optical signal, wherein the modulated optical signal comprises a carrier laser signal in which one or more symbols have been encoded as phase or frequency modulations of the carrier laser signal. The ring resonator can be configured to split, at the coupling region, the modulated optical signal into a first portion to be routed through the ring and a second portion passed to the output region of the ring resonator and to mix, at the coupling region, previously-received first portions of the modulated optical signal in the ring resonator with the second portion of a currently received portion of the modulated optical signal to obtain, at the output region of the ring resonator, a mixed signal. A measured energy of the mixed signal as a function of time can include a first component associated with the carrier laser signal, and a second component associated with the phase or frequency modulations of the carrier laser signal, a detuning of the ring resonator and a coupling coefficient k² of the ring resonator. The optical demodulator can include a photodetector configured to receive the mixed signal, wherein the first component of the mixed signal can be removed based on a detuning-based phase change to obtain the second component. The one or more symbols have a symbol length. The coupling coefficient k² expresses a ratio of a power of light energy routed to the ring relative to a power of light energy routed to the output region of the ring resonator, and has a value of less than 50%.

In some embodiments, a method includes receiving, over time, a modulated optical signal at an input portion of a ring resonator, wherein the ring resonator has a ring with a ring length and the ring resonator comprises a coupling region and an output region, and wherein the modulated optical signal comprises a carrier laser signal in which one or more symbols have been encoded as phase or frequency modulations of the carrier laser signal. The method further includes splitting, at the coupling region, the modulated optical signal into a first portion to be routed through the ring and a second portion passed to the output region of the ring resonator. The method also includes mixing, at the coupling region, previously-received first portions of the modulated optical signal in the ring resonator with the second portion a currently received portion of the modulated optical signal to obtain, at the output region, a mixed signal, wherein a measured energy of the mixed signal as a function of time comprises a first component associated with the carrier laser signal, and a second component associated with the phase or frequency modulations of the carrier laser signal, a detuning of the ring resonator and a coupling coefficient k² of the ring resonator. The method includes measuring the measured energy of the mixed signal from the output region using a photodetector, wherein the first component of the mixed signal can be removed based on a detuning-based phase change to obtain the second component. The one or more symbols have a symbol length. The coupling coefficient k² expresses a ratio of a power of light energy routed to the ring relative to a power of light energy routed to the output region of the ring resonator, and has a value of less than 50%.

Any single one or any combination of the following features may be used with the example embodiments described above. The modulated optical signal can be received via a multi-mode fiber. A ratio of ring length to symbol length can be less than one. The measured energy at the output region of the ring resonator can be given by:

$${I}_{out} ( t ) = ( 1 - {k}^{2} ) \cdot {\vert {\sum }_{p = 0}^{∞} A ( t - p \cdot Δ t ) \cdot {e}^{i φ ( t - p \cdot Δ t )} \cdot {( - {k}^{2} \cdot {e}^{i \cdot 4 π \cdot \frac{Δ L}{λ}} )}^{p} \vert}^{2}$$

where A(t) and φ(t) are the amplitude and the phase of the input signal, where λ is a wavelength of the carrier laser signal, ΔL is a difference between a resonant length of the ring and an actual length of the ring and detuning of the ring resonator can be given by

$$\frac{Δ L}{λ} .$$

The detuning-based phase change of the first component can be a function of

$$\frac{Δ L}{λ} .$$

The ring resonator can be a circular cavity formed in at least one of a silicon substrate or a silicon nitride substrate.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A through 1D illustrate example aspects of technical challenges associated with demodulating phase-modulated optical signals according to this disclosure;

FIG. 2 illustrates an example system for demodulating a phase-modulated optical signal according to this disclosure;

FIG. 3 illustrates an example graph showing efficiency gains for demodulating a phase-modulated optical signal according to this disclosure; and

FIG. 4 illustrates an example method for demodulating a phase-modulated optical signal according to this disclosure.

### DETAILED DESCRIPTION

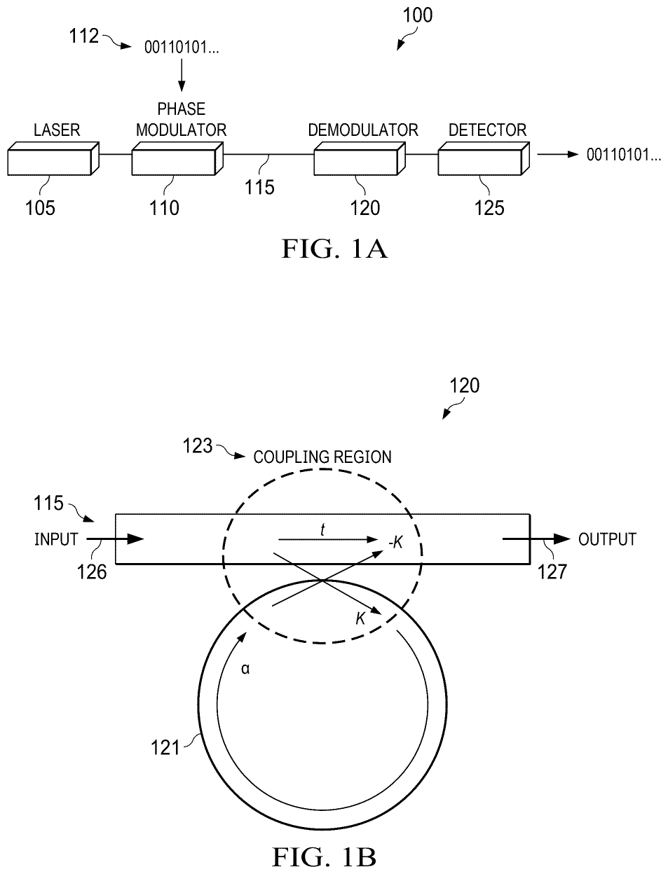

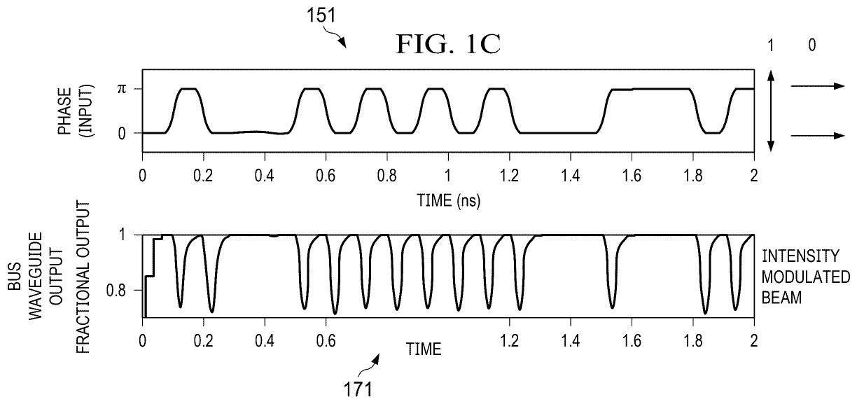

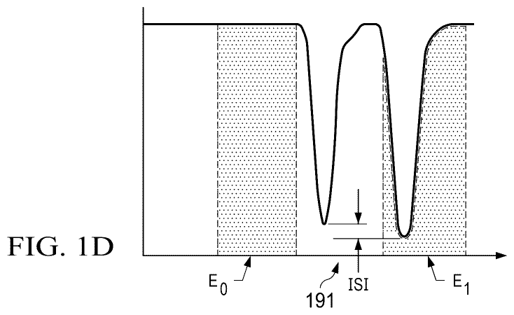

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, increasing the efficiency of systems that encode data as modulations of a parameter (such as the phase or frequency) of a waveform, transmit the modulated waveform to a receiver over a transmission medium, and recover the encoded data through demodulation of the waveform is a persistent challenge. When data is encoded by modulating the phase or frequency of a laser carrier signal, technical challenges associated with achieving system efficiency can include minimizing the effects of inter-symbol interference (ISI), where energy from previously-transmitted data interferes with the demodulation and recovery of subsequently-transmitted data.

Example challenges of maximizing data throughput include, without limitation, navigating physical and operational limits of components in a signal chain between a transmitter and a receiver. For example, a detector can be bandwidth- and amplitude-limited in terms of frequencies and signal-to-noise ratios at which demodulated signals can be detected for recovery of data. For signal features to be accurately recognized as zeros and ones forming bits of data, signal features typically need to exhibit sufficient contrast in energy and be of sufficiently-long temporal duration to be detected. Additionally, where a ring resonator or other resonant structure is used as a delay line for coupling a time-offset signal with a received signal, residual energy from previously received symbols still in the resonant structure can give rise to inter-symbol interference, diminishing system efficiency and performance. This disclosure provides for demodulation of phase-modulated optical signals using ring resonators that overcome these or other issues.

FIGS. 1A through 1D illustrate example aspects of technical challenges associated with demodulating phase-modulated optical signals, as well as ring resonators according to this disclosure. As shown in FIG. 1A, an example system 100 for transmitting and receiving phase-modulated optical signals is shown. System 100 includes a laser 105 or other optical source, a phase modulator 110, a section of fiber 115 or other transmission medium, a demodulator 120, and a photodetector 125. Laser 105 can represent any laser or other optical source suitable for use as a carrier signal source in fiber optic signaling or other optical signaling. For example, laser 105 may include a Fabry-Perot laser, a vertical cavity surface emitting (“VCSEL”) laser, a distributed feedback laser (“DFB”), or an electro-absorption modulated laser (“EML”). Laser 105 generates a waveform for transmission over fiber 115 or other transmission medium, and the waveform can have a phase that is modulated by phase modulator 110 to encode data 112 for transmission. In some embodiments, phase modulator 110 can be integral with and form a part of laser 105. In other embodiments, phase modulator 110 can be a separate component, such as a lithium niobate-based interferometer. Fiber 115 includes a section of single-mode or multi-mode fiber over which the phase-modulated optical signal from laser 105 and phase modulator 110 can propagate. Demodulator 120 is configured to receive the phase-modulated optical signal and convert the phase-modulated optical signal to a mixed signal, which (when detected by photodetector 125) reflects the phase modulations performed by phase modulator 110.

As shown in FIG. 1B, demodulator 120 includes a ring resonator 121 (sometimes referred to as a micro-ring). Ring resonator 121 comprises an input region 126, which connects to fiber 115, and guides received light energy to coupling region 123. Ring resonator 121 includes a ring cavity associated with a round-trip time τ (also known as a “ring length”), where Δt represents a time required for light of a given wavelength to traverse the ring cavity once. Coupling region 123 splits a percentage (expressed according to a coupling coefficient K²) of a signal received at time t into a first portion (which is diverted along ring resonator 121) and a second portion (which is not diverted). Coupling region 123 also mixes the second portion of the signal received at time t with the first portion of the signal previously received at time t−Δt, thereby superimposing some of the presently-received optical signal with some of the previously-received optical signal to provide a mixed signal which obtained at output region 127, which can connect to a photodetector or other measurement apparatus. In other words, ring resonator 121 operates as a delay line for a first portion of the energy in the received optical signal. The percentage of the energy of the received optical signal that is diverted to the ring resonator 121 can be specified by a coupling coefficient, which can have a value between 0% and 100%.

In conventional, correlation-based demodulators, a phase-modulated signal can be demodulated based on the mixed signal generated through the superposition of part of the currently-received signal and part of the previously-received signal. Correlation-based approaches typically strive to measure correlation between consecutive symbols, where the measured energy of the mixed signal is a direct proxy for the phase of the symbol. Measuring correlation generally involves tuning the round-trip time Δt of the ring resonator or other delay source to be equivalent to the symbol length, or time needed to transmit a data symbol, where a data symbol includes one or more bits (0 or 1 values) of data.

By setting the delay provided by ring resonator 121 to the symbol length, the superposition of the second portion of the currently-received symbol with the first portion of the previously-received symbol demodulates the phase-modulated signal into an amplitude-modulated signal, from which changes in the bit value of the currently-received symbol relative to a previously-received symbol can be determined. The extent to which energy in ring resonator 121 interferes with energy input into ring resonator 121 depends fundamentally on the relative phasing between consecutive symbols. Where consecutive symbols are in phase, mixing part of a symbol with part of a previously-received (and similarly-phased) symbol routed through ring resonator 121 produces constructive interference, and the measured energy of the mixed signal reflects the common phasing. Similarly, where consecutive symbols are out of phase, mixing part of a symbol with part of a previously-received symbol of different phase produces destructive interference, and the measured energy of the mixed signal directly correlates with the phase difference.

While this approach proceeds naturally and logically from the underlying mathematics describing modulation and correlation-based demodulation of phase-modulated optical signals, real-world implementation of this approach can present significant performance bottlenecks and limits on data throughput. For example, to obtain variations in measured energies from the superposition of a current symbol and a previously-received symbol of sufficient size difference to be reliably and accurately detected, coupling coefficients on the order of 50% are the norm. This may be needed since matching the measured energy of the delayed portion of the signal to the measured energy of the current portion of the signal makes cancellation or addition of the two portions more detectable. However, increasing the power of the received signal and coupling coefficient can add an excess of energy in ring resonator 121, thereby hampering performance. As skilled artisans will appreciate, ring resonator 121 resonates. After the first portion of a signal received at time t completes a lap around ring resonator 121, a percentage of the energy in the first portion equivalent to the coupling coefficient feeds back into ring resonator 121 for a second lap around ring resonator 121. For example, in a system with a coupling coefficient of 0.5, the first portion has a measured energy half that of the originally-received signal. However, 50% of the first portion (25% of the energy of the received signal) remains in ring resonator 121 for a second lap, 12.5% of the original energy remains in the ring resonator 121 for a third lap, and so on. Undissipated energy remaining in ring resonator 121 can thus become a source of inter-symbol interference, which can confound a photodetector's ability to accurately resolve phase modulations from the measured energy of the mixed signal.

As shown in FIGURES IC and ID, energy from a previously-received symbol continuing to circulate in ring resonator 121 can create inter-symbol interference (ISI), which diminishes the probability of photodetector 125 accurately differentiating between measured energies corresponding to zeros and ones. More specifically, FIG. 1C illustrates a phase modulated waveform 151 and an intensity-modulated (demodulated) waveform 171 obtained by combining a first portion of the phase-modulated waveform delayed by round trip time Δt of ring resonator 121 with a second immediately-received portion of the phase-modulated signal.

FIG. 1D provides a close-up of demodulated waveform 171 to illustrate how undissipated energy from previously-transmitted signals can create inter-symbol interference in systems in which round trip time Δt is configured to match the symbol length. As shown in FIG. 1D, an initial symbol E₁ is received and demodulated by directing a first portion of a previously-received symbol E₀, the magnitude of which depends on the coupling coefficient, of the received waveform through ring resonator 121. A fraction of the first portion of symbol E₀ performs a second lap of ring resonator 121 and is superimposed with a subsequently-received symbol E₂. Thus, the measured energy of trough 191 in symbol E₁ reflects ISI from residual energy in ring resonator 121 from symbol E₀ as well as symbols received previous to E₀. As coupling coefficients increase, so too, do the magnitude and persistence (because more of the first portion is fed back to ring resonator 121 for subsequent laps of ring resonator 121) of undissipated, residual energy in the delay line of ring resonator 121.

Mitigating the effects of ISI in correlation-based demodulator systems with ring/symbol length ratios of one and coupling coefficients on the order of 50% typically requires increasing the power of the initially-transmitted optical signal. In other words, mitigating ISI in correlation-based demodulators can require operators to make an undesirable choice between decreasing efficiency (by increasing transmission power) or decreasing throughput (by slowing the data transmission rate of the system). Skilled artisans will appreciate that, in systems in which the round-trip time of a ring resonator is tuned to the symbol length, increasing the throughput (increasing the number of symbols demodulated per second) requires re-tuning or replacing the ring resonator, which can be undesirable in real-world applications.

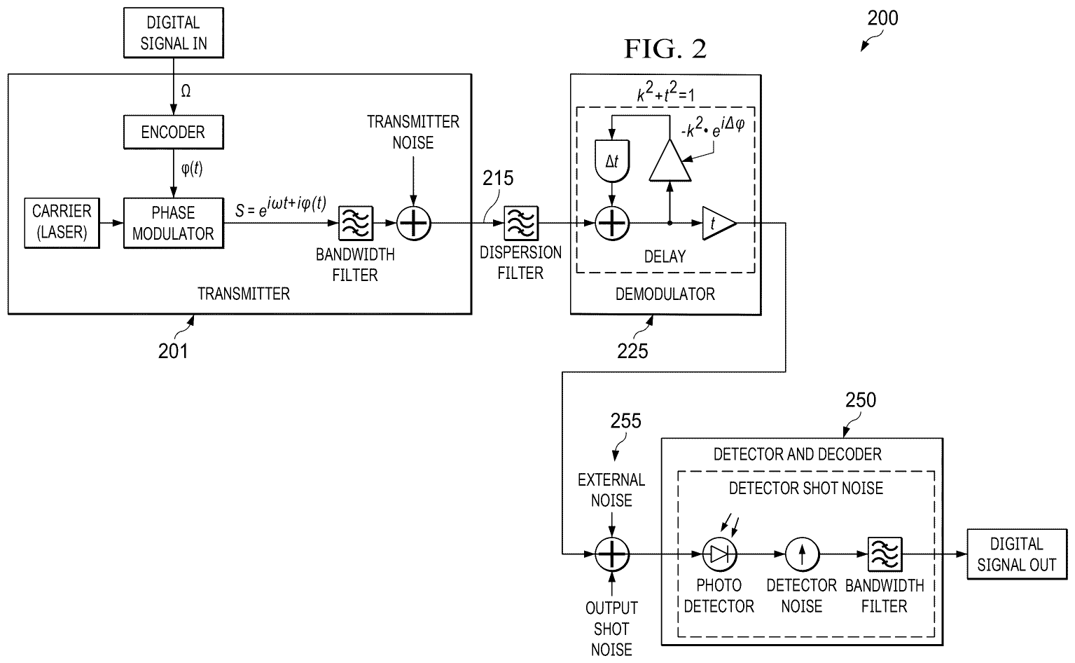

FIG. 2 illustrates an example system 200 for demodulating a modulated optical signal according to this disclosure. In general, the system 200 can realize performance gains over correlation-based demodulators by (i) shortening the length of a ring resonator, (ii) reducing a coupling coefficient between a portion of a received signal diverted to the ring resonator, and/or (iii) measuring the energy of a mixed signal whose fluctuations depend at least partially upon a rate of phase change in the modulated signal. Unlike correlation-based demodulators, embodiments of this disclosure allow for the use of a significantly detuned ring resonator, wherein the round-trip time Δt of the ring resonator of a demodulator is less than the symbol length.

As discussed below, diverting a smaller portion of the energy of a received modulated optical signal to a ring resonator operating as a delay line and using a shorter ring resonator can produce a mixed signal whose waveform properties can be accurately detected by a photodetector, and which leaves less residual energy from previously transmitted symbols in the ring resonator. In some cases, the photodetector can have the same sensitivity and bandwidth as those used for correlation-based demodulation without incurring ISI-related performance penalties associated with high coupling coefficients and ring/symbol length ratios of one. By measuring phase changes within a mixed signal, the portion of the mixed signal associated with a laser carrier signal (which exhibits a predictable and recurrent phase shift due to the detuning of the ring resonator) can be readily separated from the portion of the mixed signal associated with the modulations, and equivalent or improved bit error rates (BERs) for data encoded as modulations in the received signal can be achieved more efficiently at significantly lower power and coupling coefficients than by correlation-based techniques. In addition to attaining equivalent or better bit error rates for a given transmission power level, embodiments of this disclosure can improve performance by increasing the range of data transmission rates for a given demodulator size and improving the ability to handle signals with larger distortions, such as those found in multi-mode fibers or in longer fiber runs between a transmitter and a receiver.

As shown in FIG. 2, system 200 includes a transmitter 201 connected via a fiber 215 or other transmission medium to demodulator 225, which provides an optical signal to detector/decoder 250. Transmitter 201 receives a digital signal including data to be transmitted over fiber 215. Transmitter 201 encodes the received digital signal as phase modulations φ of an optical carrier signal of frequency ω, where the phase modulations of the optical carrier signal correspond to symbols encoding one or more bits of data. This generates a complex (i.e., phase- or frequency-modulated) light waveform S, which in some cases, may be defined as follows.

$$s = A ( t ) {e}^{i φ ( t ) + i ω ( t )}$$

Where is A(t) is a function defining the time-variant contribution of an electric field. Modulated signal S is passed to fiber 215 or other transmission medium, which in some cases, may represent a section of single-mode or multi-mode fiber. The fiber 215 or other transmission medium acts as a dispersion filter for the transmitted signal S.

Modulated signal S is received by demodulator 225, which can have a similar form as that shown in FIG. 1B. For example, demodulator 225 includes a ring resonator (such as a circular cavity formed in a section of a silicon substrate or a silicon nitride substrate) with a round trip time Δt. Demodulator 225 can embody the structure of ring resonator 12 in FIG. 1B, to include an input region, an output region, and a coupling region in which modulated signal S can be split to route a first portion having a measured energy determined by the coupling coefficient along the ring resonator. A previously-received portion the energy of modulated signal S routed along the ring resonator can, in the coupling portion of the ring resonator, be mixed with a currently-received portion of modulated signal S, to obtain a mixed signal with a time-dependent measured energy value given by Iₒᵤₜ. In some embodiments, the ring resonator is shortened, and Δt is less than the length of the symbols encoded at transmitter 201. In other words, in embodiments according to this disclosure, the ring/symbol length ratio can be less than one. Instead, demodulation can be performed based on a mixed signal whose measured energy has a component with a predictable phase change, which can be subtracted out to isolate the portion of the measured energy associated with the modulations of a laser carrier in which data has been encoded. The predictable phase change of the component of Iₒᵤₜ associated with the carrier laser signal is a function of the detuning of the ring resonator, implying that, in embodiments according to this disclosure Δt does not need to be equivalent to the symbol length of the encoded data or that the correlation coefficient be at or around 50%. In some embodiments, Δt can be on the order of 60% (±5%) of the symbol length (a ring/symbol length ratio of 0.6), and the coupling coefficient can less than 45%, less than 40%, or less than 35% (such as around 30%). Also, in some embodiments, ring/symbol length ratios between 0.4 and 0.8 may be used.

Detector/decoder 250 can include a photodetector for obtaining measurements of the measured energy over time of the mixed signal obtained by mixing a first portion of demodulated signal S delayed by Δt due to traversing the ring resonator with a second undelayed portion. In some embodiments, detector/decoder 250 may be configured to include one or more models of to account for predicted or expected noise components of the measured energy Iₒᵤₜ of the mixed signal obtained from demodulator 225. Also, in some embodiments, system 200 may include a model 255 to account for predicted or known sources of external noise, or shot noise associated with the operation of the system as a whole.

Although FIG. 2 illustrates one example of a system 200 for demodulating a modulated optical signal, various changes may be made to FIG. 2. For example, while FIG. 2 illustrates one example system where demodulating a modulated optical signal may be used, this functionality may be used in any other suitable system.

As noted previously, correlation-based demodulation techniques strive to obtain a mixed signal whose measured energy directly correlates to the phase of the current symbol by mixing a portion of a currently-received symbol with a portion of a previously-transmitted symbol routed through a ring resonator. However, such techniques are predicated on coupling coefficients of about 50% and ring resonators whose round-trip times Δt are of equal length to data symbols. Because of this, inter-symbol interference due to undissipated energy in ring resonators from previously received symbols can diminish accuracy and increase bit error rates due to the energy levels of the mixed signal being distorted upwards or downwards by ISI and not presenting variations in measured energy from which a symbol's phase can be accurately read. In systems where the ring length is tuned to the symbol length, decreasing the bit error rate may only be achieved by increasing the transmission power of the modulated signal. While such “brute force” approaches may work, they are inefficient and unsuitable for use with signals transmitted along multi-mode fiber from which rates of phase change can be measured but which do not have a well-defined phase.

Instead of expressing the phase of a symbol according to values above or below a single binary threshold, embodiments of this disclosure isolate the component of the measured energy at the output of a detuned (i.e., having a shorter (less than a full symbol length) ring resonator associated with the modulation of a laser carrier signal. Because embodiments according to the present disclosure isolate the component of the signal associated with modulation, they are equally effective for demodulating both phase- and frequency-modulated signals.

Because they are not premised on additive or subtractive correlation of subsequent symbols, embodiments of this disclosure effect a two-pronged reduction of ISI by (i) diminishing energy in a ring resonator available to interfere with subsequent symbols by reducing the coupling coefficient and (ii) accelerating the dissipation of energy in the ring resonator by shortening the round-trip time Δt of the ring. For example, if it takes five laps around a ring resonator to dissipate the energy of a previously-transmitted symbol to a level where no ISI from the previously-transmitted symbol can be observed for a given coupling coefficient n, shortening the round-trip time of the ring resonator hastens the dissipation of residual energy in the ring resonator.

As noted above, embodiments according to the present disclosure can demodulate a received signal in which data has been encoded as modulations of phase and/or frequency of a laser carrier signal. An initial signal S (shown below)

$$S = A ( t ) {e}^{i φ ( t ) + i ω ( t )}$$

once received and passed to the coupling portion of demodulator 225, becomes signal Sᵢₙ, (shown below) after a portion \vec{k} of the energy of S is diverted to the ring resonator of demodulator 225. Sᵢₙ can be expressed as the product of three time-dependent components: (1) an amplitude component A(t); (2) an expression e^{iφ(t)} describing the modulation of the phase and/or frequency of a carrier laser signal; and (3) an expression e^{i(ωt-\vec{k}\vec{r})} describing the carrier laser signal itself, along with an adjustment for a propagation constant \vec{k}.

$${S}_{in} = A ( t ) \cdot {e}^{i φ ( t )} \cdot {e}^{i ( ω t - \vec{k} \vec{r} )}$$

Input signal Sᵢₙ is combined, at a coupling region of the ring resonator, with a portion of energy previously received at a time Δt prior to t, where Δτ is a roundtrip time around the ring resonator. Thus, and as discussed elsewhere in this disclosure, the energy Iₒᵤₜ at the output portion of ring resonator comprises a portion of previously received energy proportional to the coupling coefficient and delayed by the roundtrip time Δt of the ring resonator, and a portion of the currently received energy proportional to one-minus the coupling coefficient, and some residual energy from previously-received symbols. Specifically, Iₒᵤₜ can be given by the expression:

$${I}_{out} = ( 1 - {k}^{2} ) \cdot {\vert {\sum }_{p = 0}^{∞} A ( t - p τ ) \cdot {e}^{i φ ( t - p ( τ + Δ τ ) )} \cdot {( - {k}^{2} \cdot {e}^{i \cdot 4 π \cdot \frac{Δ L}{λ}} )}^{p} \vert}^{2}$$

where Δτ is the roundtrip time of the ring resonator, λ is the wavelength of the carrier laser signal, wherein ΔL is a difference between a resonant length of the ring resonator and the actual length of the ring resonator, and

$$\frac{Δ L}{λ}$$

is a quantification of the extent to which the ring resonator is detuned. As used in this disclosure the expression, “detuned” encompasses a difference between the roundtrip time of the ring resonator in the demodulator relative to a “tuned” roundtrip time. In certain embodiments, detuning can be expressed as:

$$\frac{Δ L}{λ} = frac ( \frac{c \cdot Δ τ}{λ} )$$

where c is the speed of light.

Notably, and as illustrated by the expression for Iₒᵤₜ, above the component of Iₒᵤₜ associated with the carrier laser signal (as opposed to the modulations thereof) consistently experiences a predictable and ongoing phase change proportional to the detuning

$$\frac{Δ L}{λ}$$

of the ring resonator. Thus, provided the wavelength of the carrier laser signal, the coupling coefficient, and the roundtrip time Δt of the ring resonator are known, the component of Iₒᵤₜ associated with the carrier laser signal exhibits a predictably phase shifted component of Iₒᵤₜ which can be subtracted out to obtain energy values reflecting only the modulations to the carrier laser.

As shown above, embodiments according to the present disclosure provide a mechanism for the component of the measured energy at the output of a ring resonator demodulator associated with a carrier laser signal, to be reliably predicted and subtracted from the measured energy to leave a residual signal based on the modulation of the carrier signal. In this way, embodiments according to this disclosure avoid the accumulation of residual energy in ring resonator structures which imposes hard limits on the throughput and efficiency (i.e., power required to attain a given bit error rate) of correlation-based demodulators.

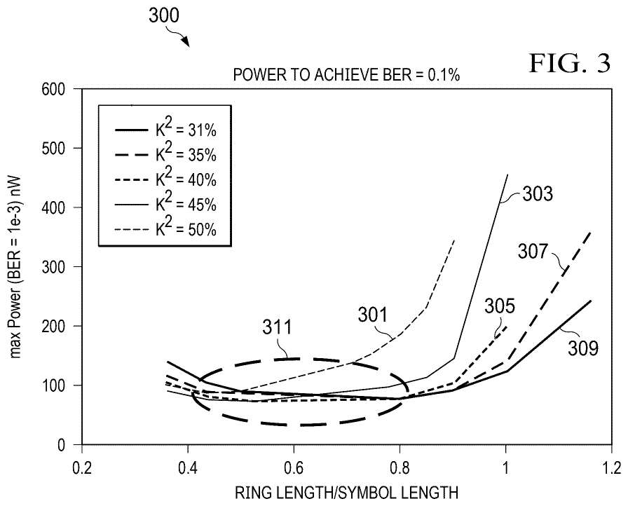

FIG. 3 illustrates an example graph 300 showing efficiency gains for demodulating a modulated optical signal according to this disclosure. More specifically, the graph 300 illustrates example efficiency gains provided by embodiments of this disclosure that lower the ring resonator length (another expression of round-trip time Δt) to symbol length ratio to values below one and lower the correlation coefficient to values under 50%. Ratios of ring length to symbol length are provided on the x axis of graph 300. Skilled artisans will appreciate that the ratio of ring length to symbol length is proportional to the value of the ring length times transmission rate. Values of the maximum power used to attain a bit error rate (BER) of 0.1% are shown along the y axis of graph 300.

Plot 301 shows the maximum transmission power, in nanowatts, used to achieve a BER of 0.1% with a correlation constant of 50% as a plot of ring length/symbol length values. Plot 301 shows that the power used to attain a 0.1%-bit error rate spikes upwards at ring/symbol length values greater than about 0.82. Plot 303 shows the maximum transmission power used to achieve a BER of 0.1% with a correlation constant of 45% as a plot of ring length/symbol length values. Plot 303 shows a pronounced spike in the used transmission power at ring/symbol length values greater than about 0.82. Plots 305, 307 and 309 show maximum transmission power as a function of ring/symbol length ratio for correlation values of 40%, 35%, and 31%, respectively.

Note that none of plots 305, 307 or 309 do not exhibit the same rate of increase in power to achieve a 0.1% BER as the ring/symbol length ratio approaches unity. Also, each of plots 305, 307 and 309 is substantially flat around a maximum power value of 100 nanowatts (nW) over a range 311 of ring/symbol length ratios between about 0.45 and about 0.8. In addition to being evidence that embodiments of this disclosure can provide efficient and accurate demodulation over a range of coupling coefficients and ring/symbol length ratios, this implies that embodiments of this disclosure can provide higher transmission rates at lower transmission powers than systems whose ring-to-symbol length ratios and coupling coefficients are configured to perform correlation-based demodulation.

Although FIG. 3 illustrates one example of a graph 300 showing efficiency gains for demodulating a modulated optical signal, various changes may be made to FIG. 3. For example, the specific contents shown in FIG. 3 are examples only and merely meant to illustrate how one specific implementation of a demodulator may operate.

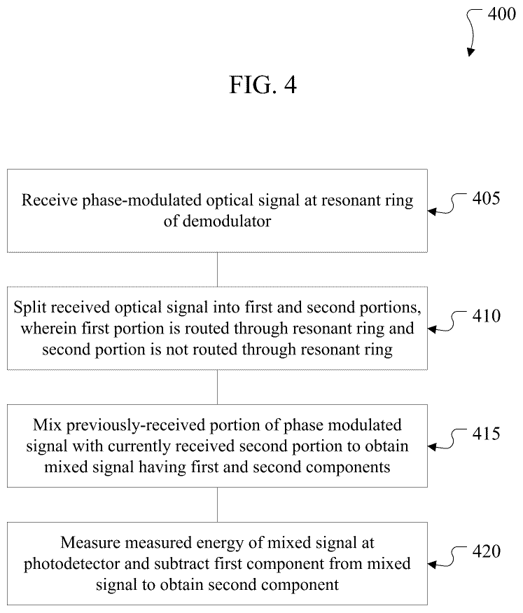

FIG. 4 illustrates an example method 400 for demodulating a modulated optical signal according to this disclosure. For ease of explanation, the operations of FIG. 4 are described as being performed using system 200 in FIG. 2. However, method 400 may be performed using any other suitable system.

At operation 405, a modulated optical signal is received, such as via an optical fiber or other transmission medium, from a transmitting device at a ring resonator of a demodulator (for example, demodulator 225 in FIG. 2). The ring resonator comprises a ring with a ring length Δτ and an input region, a coupling region and an output region.

The received modulated optical signal can comprise a carrier signal in which one or more data symbols have been encoded as phase or frequency modulations of the carrier laser signal. In some cases, the ring resonator can be provided as a generally-circular cavity within a silicon or silicon nitride substrate. The ring resonator includes an input region, an output region, and a coupling region, wherein light energy can enter and exit the ring resonator according to a coupling coefficient k², where k² expresses a ratio of a power of light energy (including both energy already in the ring and energy from the input portion) routed to the ring relative to the power of light energy routed to the output region. In some embodiments, the coupling coefficient may be less than 50%. The ring resonator has a ring length, and the modulated optical signal includes one or more symbols having a symbol length. A ratio of the ring length to symbol length is less than one. In other words, it takes longer for a full symbol of data to be transmitted/received than for light to make a single round trip around the ring resonator.

At operation 410, the modulated optical signal is split at the coupling region of the ring resonator into a first portion and a second portion. The first portion is routed through the ring to introduce a delay equivalent to the ring length of the ring resonator, and the second portion is to the output region.

At operation 415, previously-received first portions of the modulated optical signal in the ring resonator are mixed with the second portion of a currently-received portion of the modulated signal to obtain a mixed signal at the output region of the ring resonator. Because the first and second portions of the split signal are not of equal magnitude (because the coupling coefficient is less than 50%), the mixed signal obtained at operation 415 differs from a mixed signal obtained at a demodulator constructed for correlation-based demodulation. In the mixed signal obtained at operation 515, measured energy values of the mixed signal comprise the following two components: a first component associated with the unmodulated carrier signal; and a second component associated with the phase or frequency modulations applied to the carrier signal prior to transmission, a detuning of the ring resonator and the coupling coefficient k². As discussed herein, because the ring resonator is significantly detuned, the first portion exhibits a predictable detuning-based phase change, from which the first component can be identified and subtracted from the mixed signal to obtain only the second component. In some embodiments, a photodetector (for example, photodetector 250 can measure the power of the output signal to determine the power characteristics of a symbol, such as the total energy in a symbol or maximum power in a symbol, and from this, the predictable detuning-based phase change can be identified.

Although FIG. 4 illustrates one example of a method 400 for demodulating a modulated optical signal, various changes may be made to FIG. 4. For example, while shown as a series of steps, various steps in FIG. 4 may overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An optical demodulator comprising:
a ring resonator having a ring with a ring length Δτ and comprising an input region, a coupling region and an output region, wherein the ring resonator is configured to:
receive, at the input region over time, a modulated optical signal, wherein the modulated optical signal comprises a carrier laser signal in which one or more symbols have been encoded as phase or frequency modulations of the carrier laser signal;
split, at the coupling region, the modulated optical signal into a first portion to be routed through the ring and a second portion passed to the output region of the ring resonator; and
mix, at the coupling region, previously-received first portions of the modulated optical signal in the ring resonator with the second portion of a currently received portion of the modulated optical signal to obtain, at the output region of the ring resonator, a mixed signal, wherein a measured energy of the mixed signal as a function of time comprises a first component associated with the carrier laser signal, and a second component associated with the phase or frequency modulations of the carrier laser signal, a detuning of the ring resonator and a coupling coefficient k² of the ring resonator; and
a photodetector configured to receive the mixed signal, wherein the first component of the mixed signal can be removed based on a detuning-based phase change to obtain the second component;
wherein the one or more symbols have a symbol length; and
wherein the coupling coefficient k² expresses a ratio of a power of light energy routed to the ring relative to a power of light energy routed to the output region of the ring resonator, and has a value of less than 50%.

2. The optical demodulator of claim 1, wherein the modulated optical signal is received via a multi-mode fiber.

3. The optical demodulator of claim 1, wherein a ratio of ring length to symbol length is less than one.

4. The optical demodulator of claim 1, wherein the coupling coefficient k² is less than 40%.

5. The optical demodulator of claim 1, wherein the coupling coefficient k² is less than 30%.

6. The optical demodulator of claim 1, wherein the ratio of ring length to symbol length is less than 0.8.

7. The optical demodulator of claim 1, wherein the ratio of ring length to symbol length is less than 0.6.

8. The optical demodulator of claim 1, wherein the measured energy at the output region of the ring resonator is given by:
$${I}_{out} = ( 1 - {k}^{2} ) \cdot {\vert {\sum }_{p = 0}^{∞} A ( t - p \cdot Δ t ) \cdot {e}^{i φ ( t - p \cdot Δ t )} \cdot {( - {k}^{2} \cdot {e}^{i \cdot 4 π \cdot \frac{Δ L}{λ}} )}^{p} \vert}^{2}$$
wherein λ is a wavelength of the carrier laser signal;
wherein ΔL is a difference between a resonant length of the ring and an actual length of the ring; and
wherein detuning of the ring resonator is given by
$$\frac{Δ L}{λ} .$$

9. The optical demodulator of claim 8, wherein the detuning-based phase change of the first component is a function of
$$\frac{Δ L}{λ} .$$

10. The optical demodulator of claim 1, wherein the ring resonator comprises a circular cavity formed in at least one of a silicon substrate or a silicon nitride substrate.

11. A method comprising:
receiving, over time, a modulated optical signal at an input portion of a ring resonator, wherein the ring resonator has a ring with a ring length and the ring resonator comprises a coupling region and an output region, and wherein the modulated optical signal comprises a carrier laser signal in which one or more symbols have been encoded as phase or frequency modulations of the carrier laser signal;
splitting, at the coupling region, the modulated optical signal into a first portion to be routed through the ring and a second portion passed to the output region of the ring resonator;
mixing, at the coupling region, previously-received first portions of the modulated optical signal in the ring resonator with the second portion a currently received portion of the modulated optical signal to obtain, at the output region, a mixed signal, wherein a measured energy of the mixed signal as a function of time comprises a first component associated with the carrier laser signal, and a second component associated with the phase or frequency modulations of the carrier laser signal, a detuning of the ring resonator and a coupling coefficient k² of the ring resonator;
measuring the measured energy of the mixed signal from the output region using a photodetector, wherein the first component of the mixed signal can be removed based on a detuning-based phase change to obtain the second component;
wherein the one or more symbols have a symbol length;
wherein the coupling coefficient k² expresses a ratio of a power of light energy routed to the ring relative to a power of light energy routed to the output region of the ring resonator, and has a value of less than 50%.

12. The method of claim 11, wherein the modulated optical signal is received via a multi-mode fiber.

13. The method of claim 11, wherein a ratio of ring length to symbol length is less than one.

14. The method of claim 11, wherein the coupling coefficient k² is less than 40%.

15. The method of claim 11, wherein the coupling coefficient k² is less than 30%.

16. The method of claim 11, wherein the ratio of ring length to symbol length is less than 0.8.

17. The method of claim 11, wherein the ratio of ring length to symbol length is less than 0.6.

18. The method of claim 11, wherein the measured energy at the output region of the ring resonator is given by:
$${I}_{out} = ( 1 - {k}^{2} ) \cdot {\vert {\sum }_{p = 0}^{∞} A ( t - p \cdot Δ t ) \cdot {e}^{i φ ( t - p \cdot Δ t )} \cdot {( - {k}^{2} \cdot {e}^{i \cdot 4 π \cdot \frac{Δ L}{λ}} )}^{p} \vert}^{2}$$
wherein λ is a wavelength of the carrier laser signal;
wherein ΔL is a difference between a resonant length of the ring and an actual length of the ring; and
wherein detuning of the ring resonator is given by
$$\frac{Δ L}{λ} .$$

19. The method of claim 18, wherein the detuning-based phase change of the first component is a function of
$$\frac{Δ L}{λ} .$$

20. The method of claim 11, wherein the ring resonator comprises a circular cavity formed in at least one of a silicon substrate or a silicon nitride substrate.
